(19) United States
(12) Patent Application Publication
(10) Pub. No.: US 2024/0217850 A1
(43) Pub. Date: Jul. 4, 2024

(54) PROCESS CONTROL OF SILVER-ION-BASED FOOD WASH PROCESSES

(71) Applicant: SmartWash Solutions, LLC, Salinas, CA (US)

(72) Inventors: Eric Child WILHELMSEN, Milpitas, CA (US); Christopher Michael MCGINNIS, Salinas, CA (US); James M. BRENNAN, Pleasanton, CA (US)

(21) Appl. No.: 18/545,150

(22) Filed: Dec. 19, 2023

Related U.S. Application Data
(60) Provisional application No. 63/478,319, filed on Jan. 3, 2023.

(51) Int. Cl. C02F 1/70; C02F 1/32; C02F 1/62

(52) U.S. Cl. CPC C02F 1/70; C02F 1/32; C02F 1/62; C02F 2101/20; C02F 2209/06

(57) ABSTRACT

Methods and apparatus for assaying and controlling the concentration of silver ions in a wash treatment solution used in food processing are provided. One example method of controlling a wash treatment solution for a food product generally includes obtaining a sample stream of the wash treatment solution, wherein the wash treatment solution comprises silver ions; reducing the silver ions in the sample stream to form colloidal silver in the sample stream; and optically measuring a concentration of the colloidal silver in the sample stream.

### CROSS-REFERENCE TO RELATED APPLICATION(S)

This application claims priority to U.S. Provisional Patent Application No. 63/478,319, filed Jan. 3, 2023, which is assigned to the assignee hereof and hereby expressly incorporated by reference herein in its entirety as if fully set forth below and for all applicable purposes.

### BACKGROUND

### Technical Field

The present disclosure relates to food processing and, more particularly, to controlling the concentration of silver ions in a wash treatment solution used in food processing.

### Description of the Related Art

The idea of washing food before consumption originated in antiquity. The removal of soil and other materials improves the palatability and safety of many food products. The art and science related to washing food is much evolved from simple rinsing in natural waters. Today, there are many approaches to managing the chemistry and application of water to food products. These varied approaches remove undesirable materials and may prevent cross-contamination.

The addition of chemical agents and mechanical agitation enhances the effectiveness of wash systems. The addition of chemical agents and mechanical agitation also permits water reuse. Early wash systems relied on dilution to mitigate hazards. Modern wash systems use various chemistries including sanitizers like chlorine and peroxy acids to allow water recirculation. Water has been largely considered inexpensive and has been used freely to provide washed products, but increasingly the costs of water, the costs of used water disposal, and the costs of energy have prompted increased focus on water use.

### SUMMARY

The systems, methods, and apparatus of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages described herein.

Certain aspects of the present disclosure provide a method of controlling a wash treatment solution for a food product. The method generally includes: obtaining a sample stream of the wash treatment solution, wherein the wash treatment solution comprises silver ions; reducing the silver ions in the sample stream to form colloidal silver in the sample stream; and optically measuring a concentration of the colloidal silver in the sample stream.

Certain aspects of the present disclosure provide an apparatus for controlling a wash treatment solution for a food product. The apparatus includes at least one memory storing computer-executable instructions and at least one processor coupled to the at least one memory. The at least one processor is generally configured to execute the computer-executable instructions to cause the apparatus to: control reduction of silver ions in a sample stream of the wash treatment solution to form colloidal silver in the sample stream; control an optical measurement of a concentration of the colloidal silver in the sample stream; and receive an indication of the concentration of the colloidal silver in the sample stream.

Certain aspects of the present disclosure provide a system for controlling a wash treatment solution for a food product. The system generally includes: a sample metering pump configured to: obtain a sample stream of the wash treatment solution from a source of the wash treatment solution, wherein the wash treatment solution comprises silver ions; a first reagent metering pump configured to supply a stream of a first reagent to the sample stream, wherein the first reagent causes reducing of the silver ions in the sample stream to form colloidal silver in the sample stream; an optical chamber configured to enable the sample stream to pass through the optical chamber and to provide an indication of a measurement of a concentration of the colloidal silver in the sample stream; and at least one processor configured to: obtain the indication of the measurement; and control a silver ion solution pump based on the indication of the measurement, wherein the silver ion solution pump is configured to add a quantity of a silver ion solution to a reservoir of the wash treatment solution, wherein the reservoir is fluidly coupled to the source of the wash treatment solution.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIGS. 1A, 1B, and 1C are block diagrams showing a food wash system, in which aspects of the present disclosure may be practiced.

FIG. 2 is a schematic diagram of a food processing system, in accordance with aspects of the present disclosure.

FIG. 3 is a schematic diagram of a wash treatment solution control system, in accordance with certain aspects of the present disclosure.

FIG. 4 is a flow diagram of example operations for controlling a wash treatment solution, in accordance with certain aspects of the present disclosure.

To facilitate understanding, identical reference numerals have been used, where possible, to designate identical elements that are common to the figures. It is contemplated that elements described in one aspect may be beneficially utilized on other aspects without specific recitation.

### DETAILED DESCRIPTION

Aspects of the present disclosure provide apparatus, systems, and methods for assaying and controlling the concentration of silver ions in a wash treatment solution used in food processing.

Previously known wash systems used for food processing have used chemical agents and/or mechanical agitation to enhance the effectiveness of the wash systems. The chemical agents may include sanitizers like chlorine and peroxy acids. Silver ions are a relatively new addition to the family of sanitizers used for processing food. Silver ions have been known to be antimicrobial for many years and have medical uses. The cost of silver and the tendency of silver ions to be reduced to much less active elemental silver have limited the usage of silver.

Recently, silver dihydrogen citrate, which may be stable while in a solution, has been used in wash treatment solutions used in food processing. The silver dihydrogen citrate solution may be shipped as a concentrate and diluted for use on site in food-washing processes with significant microbial lethality. Silver is a precious metal and more costly to use than most other sanitizers. It is desirable to effectively use the silver and to recycle the silver to maximize usage and lower cost.

To recycle silver-ion-based sanitizers, it may be desirable to monitor and control the silver ions in the sanitizers. Although there are many silver assays, none of the known silver assays are suitable for food-washing process monitoring. Known assays include ion-selective electrodes, titrations, gravimetric as with chloride, atomic absorption, and ion-coupled plasma.

Accordingly, developing a suitable silver assay and control system suitable for controlling the concentration of silver ions in a wash treatment solution used in food processing is desirable.

The present disclosure provides apparatus, systems, and methods for assaying and controlling the concentration of silver ions in a wash treatment solution used in food processing. The provided methods include reducing silver ions in a sample stream of the wash treatment solution to form colloidal silver and optically measuring a concentration of the colloidal silver in the sample stream. For example, when the concentration of the colloidal silver in the sample stream decreases, a processor may control a metering pump to cause additional silver ions to be added to a reservoir of the wash treatment solution. The silver ions may be introduced, for example, in the form of a solution with silver dihydrogen citrate.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure described herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

As shown and described herein, various features of the disclosure will be presented. Various embodiments may have the same or similar features, and thus, the same or similar features may be labeled with the same reference numeral. Although similar reference numbers may be used in a generic sense, various embodiments will be described and various features may include changes, alterations, modifications, etc. as would be appreciated by those of skill in the art, whether explicitly described or otherwise.

### Example Silver-Ion-Based Processes for Sanitizing Food

There may be two major considerations in controlling silver-ion-based processes for sanitizing in food processing. Monitoring the silver ion concentration and controlling the composition of the sanitizing solution may both be considered when using silver-ion-based sanitizing processes. Controlling the composition of the sanitizing solution may involve controlling the silver ion concentration, as well as other characteristics of the sanitizing solution.

Assays used in a laboratory may have issues when considered for use in a production environment that can be cold, wet, and generally unforgiving to equipment. In a production environment, it is desirable for the assay to provide the relevant information quickly and involve no complex manipulations or instrumentation. It is also desirable for the assay to be stable over time in order to avoid frequent recalibration. Furthermore, it is desirable for the assay to be sensitive across the range of interest for silver, which may be 5 to 100 parts per million (ppm).

In aspects of the present disclosure, a reductive assay of silver ions is provided that has the above-described desirable features.

Silver ions are readily reduced. As used herein, the term “reduction” generally refers to the gain of electrons by a chemical substance, so the reduction of silver ions may change the silver ions to elemental silver, for example. This reduction can be affected by light, which potentiates the oxidation of many components by the silver ions. Reduction of silver ions can also be affected chemically by a wide range of reductants (also referred to herein as “chemical reducing agents” and “reducing agents”). Suitable reductants for food processing sanitizing systems may include aldehydes, mercaptans, ascorbic acid, erythorbic acid, and chemicals that are chemically similar to ascorbic acid or erythorbic acid. The action of these reductants may be enhanced by alkali conditions. There are other reductants that could be used, although many alternatives are less compatible with most processing environments where silver ion sanitizing processes may be used.

According to aspects of the present disclosure, for an assay, a stream (also referred to herein as a “sample stream”) of the wash treatment solution (also referred to herein as the “process solution” or “sanitizing solution”) is treated to reduce the silver ions to make colloidal silver, which can be measured optically, for example, by absorbance, turbidity, or light scattering. The response from such optical procedures may be calibrated to convert the response to a silver concentration. The measured concentration may be an absolute concentration in the wash treatment solution or a concentration that is relative (e.g., a relative concentration) to other components of the wash treatment solution.

In aspects of the present disclosure, determination of the concentration in any particular units during processing is not mandatory, as the objective of the process is to maintain control of the wash treatment solution. Deviations from the nominal operating conditions (e.g., lowering of the silver ion concentration or changes to the pH of the wash treatment solution) may call for corrections by the system (e.g., adding silver or adding one or more other components of the wash treatment solution), and control can be maintained with any suitable units for concentration.

In the case of the short term wash described in U.S. Pat. App. Pub. 2017/0156390 A1 to Brennan, et al., which is incorporated by reference herein, the wash treatment solution is composed of an acidulant and polyol mixture in chlorine-free water with a metered amount of silver dihydrogen citrate. Mixing the wash treatment solution with approximately 30% by volume of sodium hydroxide (NaOH) (which may be referred to herein as a “second reagent”) in a concentration of 4% may adjust the pH of the wash treatment solution to allow about 0.1 grams of ascorbic acid (which may be referred to herein as a “first reagent”) to reduce the silver ions in the wash treatment solution, generating colloidal silver. The colloidal silver may then be optically measured. As an alternative to NaOH, potassium hydroxide (KOH) or other alkali can be used, as long as no insoluble silver salts are formed. This mass of ascorbic acid can readily be converted to a fluid flow by mixing with chlorine-free water. The relative volumes may be readily adjusted to various sizes of flow cells useful for measuring the silver in a sample stream. According to aspects of the present disclosure, a suitable mixture of wash treatment solution, alkali, and ascorbic acid may depend on the precise wash treatment solution, but the principle will be the same (e.g., adjust the pH of the wash treatment solution to a predefined range and add the reducing agent or otherwise reduce the silver ions).

In aspects of the present disclosure, the wash treatment solution may be filtered prior to mixing with the alkali and acid in order to avoid product particles and other debris in the flow cell.

According to aspects of the present disclosure, the three fluids (wash treatment solution, alkali, and acid) may be mixed using Venturi mixing tubes, where the generated turbulence mixes the solutions.

In aspects of the present disclosure, the mixed and now reacted solution may be optically measured and then, in some cases, dumped to drain. The materials in the mixed and reacted solution are generally not considered hazardous.

In addition or as an alternative to reducing the silver ions using a chemical agent, the silver ions may be reduced using an optical means, such as a light source. For example, in certain aspects of the present disclosure, a sample stream of the sanitizing solution may flow through a coil wrapped around an intense light source that provides light (e.g., ultraviolet light) to cause the reduction of the silver ions. For example, a mercury lamp may provide the desired ultraviolet (UV) light.

The usage of intense light to cause the reduction of the silver ions may be less preferred than the above chemical procedure, because the light intensity may decline slowly over time. At some point, the light intensity can be insufficient to reduce the silver ions in the wash treatment solution. Preventative maintenance may prevent failures of the light-based system for reducing the silver over time.

The scale of the wash treatment solution flow through an optical system measuring the silver may be dependent on the flow cell volume of the optical measuring system. In certain aspects of the present disclosure, it is desirable for the volume of the flow cell of the optical instrument to be replaced three to five times per minute to avoid aliasing of the measurements. If lowered time resolution is acceptable in a system, then the rate of replacement of the volume of the flow cell can be reduced. In certain aspects, the flow cell may be heated to avoid condensation from accumulating.

In aspects of the present disclosure, the optical density of the flow cell and the wavelength of light used in measuring the silver may be selected to avoid interference from debris in the solution. For example, a wavelength scan of the reacted material may be performed over a suitable wavelength range. In another example, the long wavelengths of visible light may be useful for measuring the silver. In certain aspects, a fixed-wavelength opacity meter may be used to measure colloidal silver in the sample stream of the wash treatment solution. According to aspects of the present disclosure, the silver concentration may be controlled by measuring scattered light from the reacted material (e.g., at right angles).

According to aspects of the present disclosure, glass parts may be used for the flow cell and other parts of the system for assaying the silver in the wash treatment solution when effluent from the assay is not returned to the process line. When effluent from the assay is not returned to the process line, there is a minimal chance of broken glass from the flow cell and other parts of the system contaminating food in the process line of a food processing system using the disclosed techniques.

In aspects of the present disclosure, a control system for a wash treatment solution for a food washing system may have three or more functions. A first function of the control system may be to maintain the silver ion concentration of the wash treatment solution, such that silver may be recycled in a food washing system. Maintenance of the silver ion concentration may be accomplished by adding concentrated silver ions to the wash treatment solution. The control system may control a metering pump to add a solution of concentrated silver ion to the wash treatment solution.

A second function of the control system may be to maintain a desired concentration of other constituents in the wash treatment solution and a total quantity of the wash treatment solution (e.g., a solution level (also referred to as a “water level”) of the wash treatment solution) in the food washing system. Typically, controlling the concentration of the other constituents and the total quantity of the wash treatment solution may include adding an acidulant (e.g., an organic acid such as lactic acid, phosphoric acid, tartaric acid, or citric acid), a polyol (e.g., glycerin or propylene glycol), and/or chlorine-free water to a reservoir of the wash treatment solution. It is desirable for the acidulant, polyol, and water to be free of chlorine to avoid reaction with the silver ions.

A third function of the control system may be to control the pH of the wash treatment solution within a predefined range based on both the tolerance of the product for the pH and within the tolerance of the quantity of alkali added during assaying of the wash treatment solution. Controlling the pH may for example, be accomplished by the control system controlling a metering pump to add a hydroxide-supplying solution (e.g., a sodium hydroxide or potassium hydroxide solution) to the wash treatment solution.

In aspects of the present disclosure, a digital control system for a wash treatment solution for a food washing system may report various parameters (e.g., silver ion concentration and pH of the wash treatment solution) to a data storage function to have the data stored for control verification.

According to aspects of the present disclosure, a control system for a wash treatment solution for a food washing system may include a touch screen or other interface enabling a user to adjust various set points of the control system and process incoming signals. The incoming signals may include silver concentration as either an analog signal or digital output from the optical device, a level in the wash treatment solution reservoir, and the pH of the wash treatment solution. The pH may be measured with a pH electrode compatible with the wash treatment solution environment, which may be, for example, an acidic environment.

In aspects of the present disclosure, each of the reagents (e.g., ascorbic acid and sodium hydroxide) may be considered food safe and compatible with a food processing environment. That is, none of the reagents may be considered likely to contaminate food in a food processing environment or likely to facilitate microbial contamination of food or food processing equipment. In addition, the reagents described herein present only minor hazards when concentrated.

### Example Food Processing Systems

Certain aspects of the present disclosure may include a food processing system for washing food products. The food processing system may wash the food products within a wash tank, although the present disclosure is not so limited and includes food processing systems using wash stages such as wash flumes (with or without an active wash area), rotating drum washers, and/or agitated tanks where air or other mechanical agitation is used to promote cleaning. Such a food processing system may also include one or more sprayers (e.g., water curtains) configured to spray the food products with wash treatment solution, wash water of another type, and/or rinse water before and/or after the food products are washed in the wash tank.

The following description describes methods and systems for washing a food product using a short-term wash treatment and short-term wash device. A short-term wash treatment, which may also be called an “intense prewash treatment,” using a short-term wash solution and device, when combined with a wash treatment and device synergistically enhances the lethality of traditional wash systems for ready-to-eat (RTE) produce and other food products. A short-term wash treatment permits the usage of materials that would otherwise potentially damage or otherwise prevent the sale of RTE produce and other food products. For example, an intense prewash with a phosphoric acid and propylene glycol solution or with a silver dihydrogen citrate solution has proven particularly effective when exposure times are controlled and limited. The short-term wash treatment may be adjusted according to a suitable time for treating the particular product, which is generally between 30 and 60 seconds. Longer treatments (i.e., longer intervals for applying the short-term wash solution) are less practical given the product throughput and the potential for intense treatment solutions to shorten the shelf-life of the product. The product may be, for example, fresh produce that is at least one selected from a group including whole, sliced, cut, and chopped leafy greens including, but not limited to, lettuce, spinach, cabbage, and kale, and vegetables including, but not limited to, broccoli, onions, bell peppers, and squash. Alternatively, the product may be, for example, a meat product that is at least one selected from a group including beef, pork, lamb, veal, game, and poultry that includes, but is not limited to, whole, parted, and boned poultry.

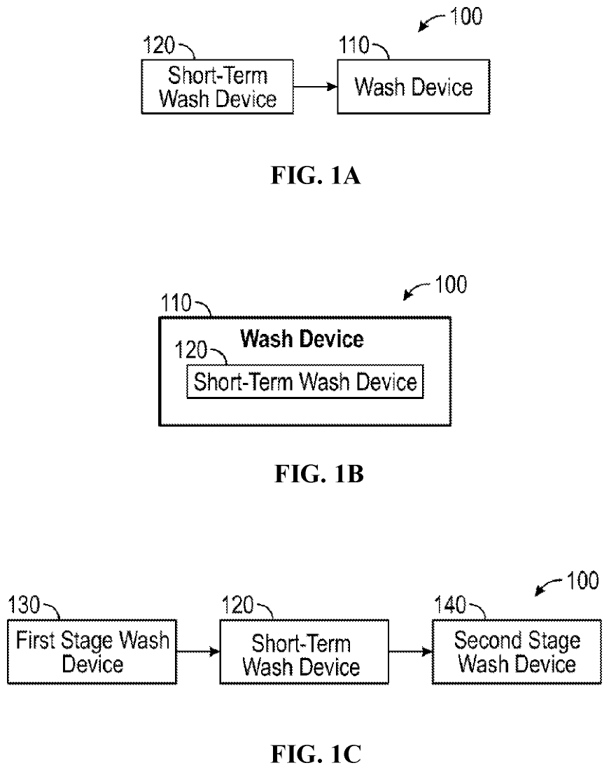

FIGS. 1A, 1B, and 1C show block diagrams of an example food product wash system 100 for washing food products, such as produce or meat. For example, FIG. 1A shows a food product wash system 100 that includes a wash device 110 and a short-term wash device 120. The short-term wash device 120 is placed to be disposed first in the process flow. Next is provided a wash device 110 that is provided after the short-term wash device 120 in the process flow such that the wash device 110 receives product/produce from the short-term wash device 120. Particularly, the short-term wash device 120 initially washes product and then provides the product to the wash device 110 which rinses the product and washes the product using a normal wash cycle.

FIG. 1B shows a food product wash system 100 that includes a wash device 110 and a short-term wash device 120. In this example, the short-term wash device 120 is provided at some point within the wash device 110. Accordingly, product that is provided to the wash device 110 will first be washed by the short-term wash device 120 and then provided to the wash device 110 for rinsing and a normal wash cycle.

FIG. 1C shows a food product wash system 100 that includes a short-term wash device 120 as well as a first stage wash device 130 and a second stage wash device 140. The first stage wash device 130 is provided before both the short-term wash device 120 and the second stage wash device 140. Accordingly, the first stage wash device 130 does a preliminary normal wash cycle. The short-term wash device 120 is provided next to receive the product from the first stage wash device 130. The short-term wash device 120 then washes the product using a short-term wash treatment and sends the product on to the second stage wash device 140. The second stage wash device 140 receives the product and proceeds to rinse and wash the product using a normal wash cycle similar to the first stage wash device 130. Providing the first stage wash device 130 first allows that wash cycle to deal with the initial product load so that the short-term wash device can be better controlled and applied consistently to the product.

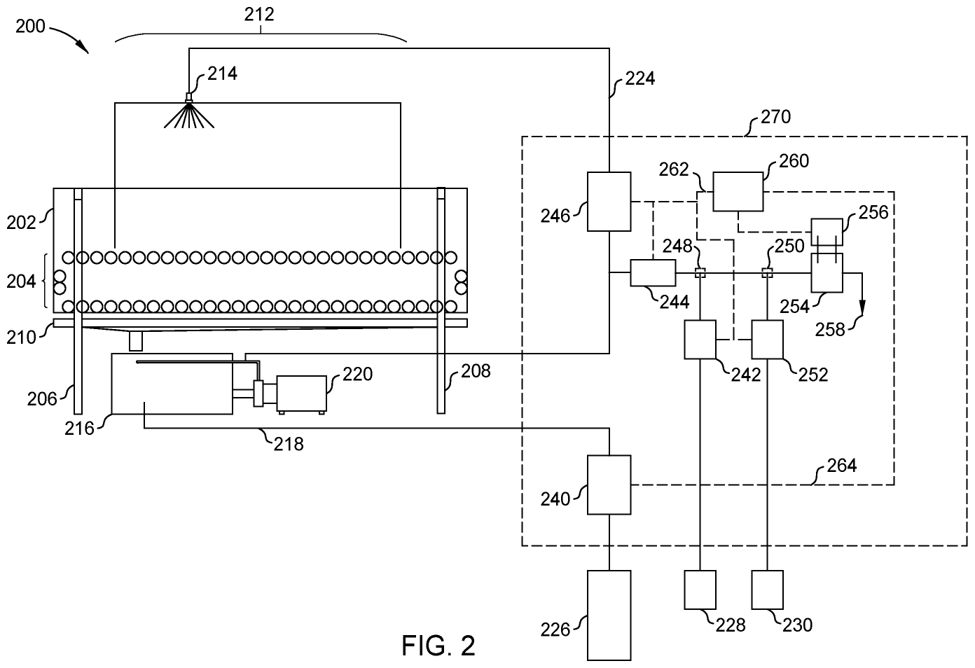

FIG. 2 is a schematic diagram of a food processing system 200 (also referred to herein as a “process line”), in accordance with aspects of the present disclosure. In FIG. 2, pipes for conveying fluids are shown as solid lines, while wires for control signals are shown as two short dashes between longer dashes. While control signals are illustrated as occurring on wires, the present disclosure is not so limited, and at least some control signals may be conveyed wirelessly. In some aspects, the food processing system 200 may be an example of a short-term wash device 120, as illustrated in FIGS. 1A, 1B, and 1C. The food processing system 200 may be a single-stage food processing system or part of a multi-stage food processing system. The food processing system 200 includes a food processing container 202 that contains a food product (e.g., fruit with a rough surface (e.g., a reticulated surface), such as netted melons) being processed. The food is supplied to the food processing container 202 via a conveyor 206 or other device (e.g., a hopper), and the food product is removed from the food processing container 202 via another conveyor 208. The food product is conveyed via a roller conveyor belt 204 through an applicator 212 (e.g., a spray curtain or fogging chamber) in which a wash treatment solution is applied to (e.g., sprayed on) the food product. The wash treatment solution is applied to the food product via one or more nozzles 214.

Wash treatment solution may exit the applicator 212 and food processing container 202 via the bottom (e.g., through a screen or holes) of the food processing container 202. At least some of the wash treatment solution that exits the food processing container 202 is caught in a catch tray 210, which drains into a wash treatment solution reservoir 216.

Wash treatment solution may be pumped by a pump 220 from the wash treatment solution reservoir 216 via a pipe (or line) 222. Most of the wash treatment solution from the wash treatment solution reservoir 216 may be supplied to a high pressure pump 246. Wash treatment solution supplied to the high pressure pump 246 is pumped by the high pressure pump 246 via a pipe (or line) 224 to the nozzles 214.

A system 270 for controlling the wash treatment solution is included in the food processing system 200, according to aspects of the present disclosure. The system 270 includes at least one processor (e.g., a programmable logic controller (PLC)) or other controller 260 that controls operations of the system 270 and may also control operations of the food processing system 200, according to aspects of the present disclosure. For example, the controller 260 may be or may include an Automated SmartWash Analytical Platform (ASAP)™ available from SmartWash Solutions, LLC of Salinas, California.

The system 270 also includes a sample metering pump 244 that obtains a sample stream of wash treatment solution from the pipe 222. The sample metering pump 244 pumps the sample stream of the wash treatment solution at a controlled rate to a Venturi mixing tube 248 or another means of mixing fluids.

The system 270 also includes a first reagent metering pump 242 which pumps a first reagent from a first reagent reservoir 228 at a controlled rate to the Venturi mixing tube 248. The first reagent and the sample stream of the wash treatment solution mix in the Venturi mixing tube 248. The first reagent metering pump 242 may be controlled (e.g., by the controller 260) to supply the first reagent at a rate to cause the sample stream to have a pH in a predefined range.

From the Venturi mixing tube 248, the sample stream (having the pH in the predefined range) flows to another Venturi mixing tube 250 or other means of mixing fluids. A second reagent metering pump 252 pumps a second reagent from a second reagent reservoir 230 at a controlled rate to the Venturi mixing tube 250. The second reagent and the sample stream of the wash treatment solution (having the pH in the predefined range) mix in the Venturi mixing tube 250. The second reagent metering pump 252 may be controlled (e.g., by the controller 260) to supply the second reagent at a rate to reduce silver ions in the sample stream to form colloidal silver in the sample stream.

From the Venturi mixing tube 250, the sample stream with the colloidal silver flows to an optical chamber 254. A spectrometer 256 or other optical meter may measure an optical property of the sample stream in the optical chamber 254 and convert this to an indication of a concentration of the colloidal silver. The spectrometer 256 or other optical meter provides the indication of the concentration of the colloidal silver in the sample stream to the controller 260. From the optical chamber 254, the sample stream may be dumped (e.g., down a drain) to a waste disposal facility 258.

In aspects of the present disclosure, the controller 260 may control (e.g., by sending a control signal to a pump or a valve) addition of at least one of a silver ion solution, an acidulant, a polyol, and/or chlorine-free water to the wash treatment solution reservoir 216, based on the indication of the concentration of the colloidal silver obtained from the spectrometer 256 or other optical meter. For example, based on the indication of the concentration of the colloidal silver in the sample stream, the controller 260 may send one or more control signals via wire 264 to a metering pump 240 to cause the metering pump to pump silver ion solution (e.g., silver dihydrogen citrate) via a pipe 218 from a reservoir 226 to the wash treatment solution reservoir 216.

In aspects of the present disclosure, the controller 260 may also control the operations (e.g., pump rate) of the sample metering pump 244, the first reagent metering pump 242, and the second reagent metering pump 252, via one or more wires 262. The controller 260 may also control the operation of the high pressure pump 246 via the wires 262.

According to aspects of the present disclosure, the controller 260 may also obtain an indication (e.g., a measurement) of a quantity of wash treatment solution present in the wash treatment solution reservoir 216 and control (e.g., by sending a control signal to a pump or a valve) addition of at least one of an acidulant, a polyol, and/or chlorine-free water to the wash treatment solution reservoir 216, based on the indication of the quantity. In aspects of the present disclosure, the controller 260 may also obtain an indication (e.g., a measurement) of a pH of the wash treatment solution and control (e.g., by sending a control signal to a pump or a valve) addition of at least one of sodium hydroxide (NaOH), potassium hydroxide (KOH), an acidulant, a polyol, and/or chlorine-free water to the wash treatment solution reservoir 216 or to the sample stream, based on the indication of the pH.

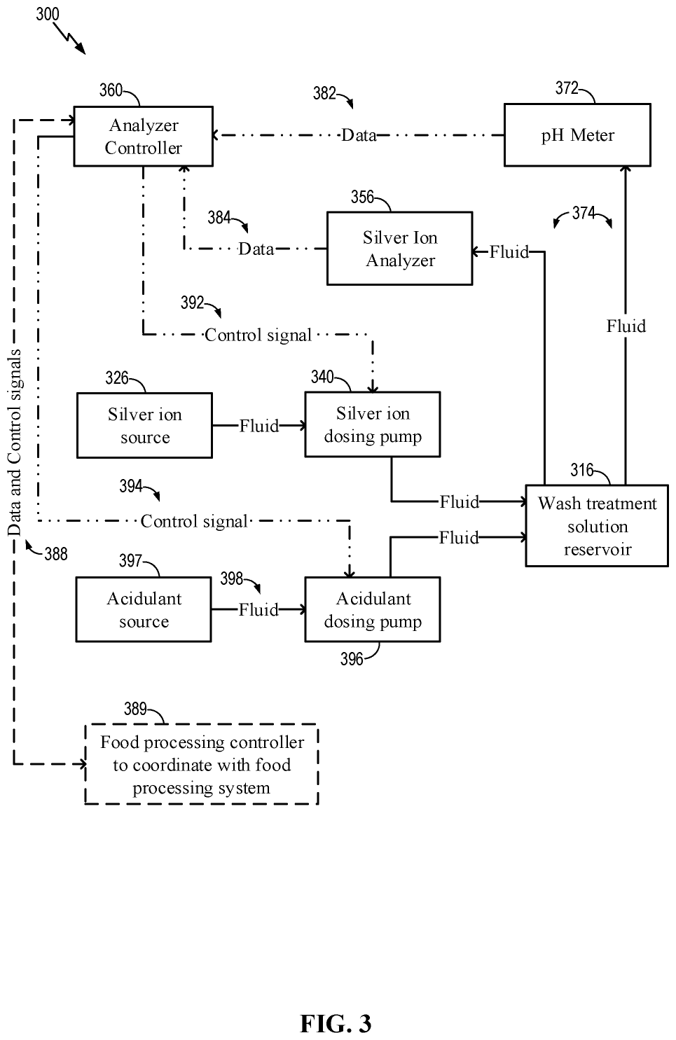

FIG. 3 is a schematic diagram of a wash treatment solution control system 300, in accordance with aspects of the present disclosure. In FIG. 3, fluid flows (e.g., via pipes) are shown as solid lines, control and data signals (conveyed, e.g., via wires or wirelessly) are shown as lines having a pattern of two dots and a dash, and optional data and control signals are shown as dashed lines. As illustrated in FIG. 3, an analyzer controller 360 (which may be similar to the controller 260 shown in FIG. 2) obtains an indication 382 of pH of a wash treatment solution 374 from a pH meter 372 that measures the pH of the wash treatment solution 374 obtained from or in a wash treatment solution reservoir 316 (which may be similar to the wash treatment solution reservoir 216 shown in FIG. 2). The analyzer controller 360 also obtains an indication 384 of a concentration of silver ions in the wash treatment solution 374 from a silver ion analyzer 356 (e.g., the spectrometer 256, shown in FIG. 2). The analyzer controller 360 sends control signals 392, based on the indication 384 of the concentration of silver ions in the wash treatment solution 374, to a silver ion dosing pump 340 (which may be similar to the metering pump 240, shown in FIG. 2) to cause the silver ion dosing pump 340 to add silver ions from a silver ion source 326 (e.g., a reservoir of silver dihydrogen citrate solution) to the wash treatment solution reservoir 316. The analyzer controller also sends control signals 394, based on the indication 382 of the pH of the wash treatment solution 374, to an acidulant dosing pump 396 to cause the acidulant dosing pump 396 to add an acidulant 398 (e.g., lactic acid) from an acidulant source 397 (e.g., a reservoir of lactic acid) to the wash treatment solution reservoir 316. The analyzer controller 360 may also optionally exchange data and control signals 388 with an optional food processing controller 389 to coordinate the wash treatment solution control system 300 with a food processing system.

### Example Methods of Controlling a Wash Treatment Solution for a Food Product

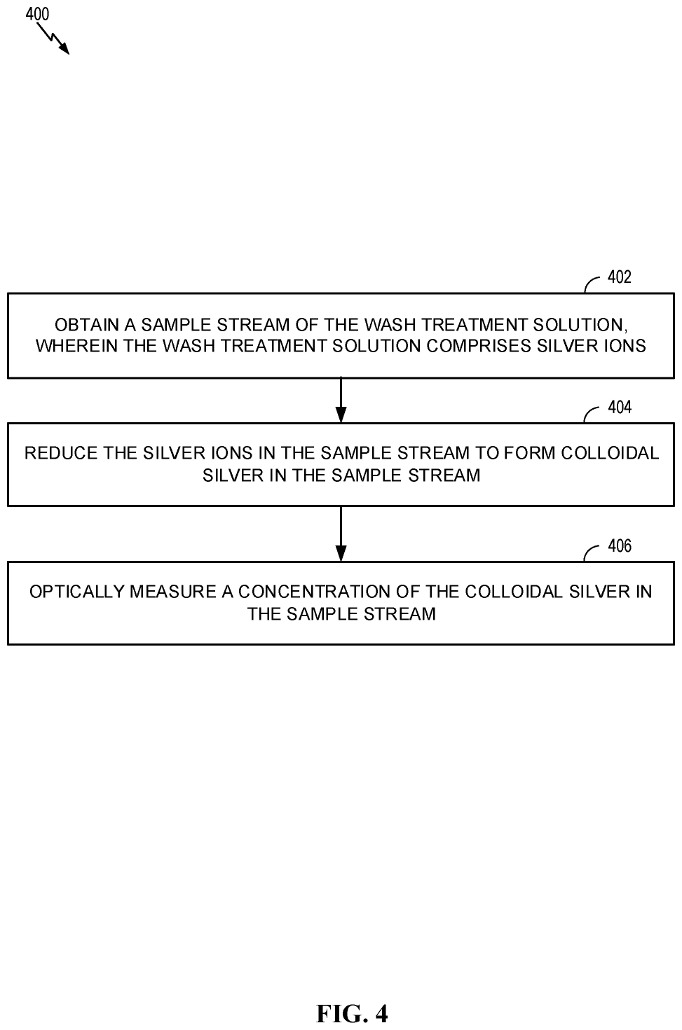

FIG. 4 is a flow diagram of example operations 400 for controlling a wash treatment solution, in accordance with aspects of the present disclosure. The operations 400 may be performed by a controller (e.g., controller 260 in FIG. 2 or analyzer controller 360 in FIG. 3) of a wash treatment solution control system (e.g., the wash treatment solution control system 270 in FIG. 2 or the wash treatment solution control system 300 in FIG. 3).

The operations 400 may begin at block 402 by obtaining a sample stream of the wash treatment solution, wherein the wash treatment solution comprises silver ions.

At block 404, the operations 400 may continue by reducing the silver ions in the sample stream to form colloidal silver in the sample stream. As an alternative to reducing the silver ions, in certain aspects, the silver ions may be otherwise adjusted (e.g., changing an oxidation state of the silver ions) to form the colloidal silver in the sample stream.

At block 406, the operations 400 may continue by optically measuring a concentration of the colloidal silver in the sample stream.

In aspects of the present disclosure, reducing the silver ions in the sample stream as in block 404 comprises mixing a first reagent with the sample stream, and the first reagent causes the reduction of the silver ions in the sample stream to form the colloidal silver in the sample stream. In some cases, the first reagent may include at least one of: an aldehyde, a mercaptan, ascorbic acid, or erythorbic acid. In some cases, mixing the first reagent with the sample stream comprises controlling a flow rate of a stream of the first reagent to cause the reduction of the silver ions in the sample stream. In some cases, mixing the first reagent with the sample stream comprises causing a stream of the first reagent to enter a Venturi mixing tube in which the sample stream is flowing.

In aspects of the present disclosure, the operations 400 further include mixing a second reagent with the sample stream before the reducing of block 404, wherein the second reagent causes the sample stream to have a pH in a predefined range. In some cases, the second reagent includes at least one of sodium hydroxide (NaOH) or potassium hydroxide (KOH). In some cases, mixing the second reagent with the sample stream comprises controlling a flow rate of a stream of the second reagent to cause the sample stream to have the pH in the predefined range. In some cases, mixing the second reagent with the sample stream comprises causing a stream of the second reagent to enter a Venturi mixing tube in which the sample stream is flowing.

In aspects of the present disclosure, reducing the silver ions in the sample stream as in block 404 includes exposing the sample stream to an ultraviolet (UV) light source. In this case, the sample stream may flow in a coil around the UV light source.

In aspects of the present disclosure, the wash treatment solution may include an acidulant, a polyol, chlorine-free water, and silver dihydrogen citrate.

In aspects of the present disclosure, optically measuring the concentration of the colloidal silver in the sample stream as in block 406 may include introducing an optical beam into the sample stream and determining at least one of an optical absorbance, optical turbidity, or optical scattering of the optical beam in the sample stream. In this case, the concentration of the colloidal silver is based on the at least one of the optical absorbance, optical turbidity, or optical scattering of the optical beam in the sample stream.

In aspects of the present disclosure, optically measuring the concentration of the colloidal silver in the sample stream may include optically measuring the colloidal silver in the sample stream in a flow cell having an internal volume between 0.5 milliliters (mL) and 1.0 mL, inclusive.

In aspects of the present disclosure, the sample stream of the wash treatment solution may have a flow rate between 1.5 milliliters per minute (mL/min) and 5.0 mL/min, inclusive.

In aspects of the present disclosure, the operations 400 may further include adding a quantity of a silver ion solution to a reservoir of the wash treatment solution, based on the measured concentration of the colloidal silver. In some cases, the silver ion solution comprises silver dihydrogen citrate.

In aspects of the present disclosure, the operations 400 may further include measuring a quantity of the wash treatment solution in a reservoir and adding a quantity of at least one of an acidulant, a polyol, or chlorine-free water to the reservoir, based on the measured quantity of the wash treatment solution.

In aspects of the present disclosure, the operations 400 may further include measuring a pH of the wash treatment solution and adding a quantity of at least one of sodium hydroxide (NaOH), potassium hydroxide (KOH), an acidulant, a polyol, or chlorine-free water to a reservoir of the wash treatment solution, based on the measured pH of the wash treatment solution.

In aspects of the present disclosure, the operations 400 may further include, based on the measured concentration of the colloidal silver, at least one of: adding a quantity of a silver ion solution to a reservoir of the wash treatment solution, adding a quantity of an acidulant to the reservoir of the wash treatment solution, adding a quantity of a polyol to the reservoir of the wash treatment solution, or adding a quantity of chlorine-free water to the reservoir of the wash treatment solution.

### EXAMPLE ASPECTS

In addition to the various aspects described above, specific combinations of aspects are within the scope of the present disclosure, some of which are detailed below.
Aspect 1: A method of controlling a wash treatment solution for a food product, comprising: obtaining a sample stream of the wash treatment solution, wherein the wash treatment solution comprises silver ions; reducing the silver ions in the sample stream to form colloidal silver in the sample stream; and optically measuring a concentration of the colloidal silver in the sample stream.
Aspect 2: The method of Aspect 1, wherein reducing the silver ions in the sample stream comprises mixing a first reagent with the sample stream of the wash treatment solution and wherein the first reagent causes the reduction of the silver ions in the sample stream to form the colloidal silver in the sample stream.
Aspect 3: The method of Aspect 2, wherein the first reagent comprises at least one of: an aldehyde; a mercaptan; ascorbic acid; or erythorbic acid.
Aspect 4: The method of any of Aspects 2-3, wherein mixing the first reagent with the sample stream comprises controlling a flow rate of a stream of the first reagent to cause the reduction of the silver ions in the sample stream.
Aspect 5: The method of any of Aspects 2-4, wherein mixing the first reagent with the sample stream comprises causing a stream of the first reagent to enter a Venturi mixing tube in which the sample stream is flowing.
Aspect 6: The method of any of Aspects 2-5, further comprising mixing a second reagent with the sample stream of the wash treatment solution before the reducing, wherein the second reagent causes the sample stream to have a pH in a predefined range.
Aspect 7: The method of Aspect 6, wherein the second reagent comprises at least one of: sodium hydroxide (NaOH) or potassium hydroxide (KOH).
Aspect 8: The method of any of Aspects 6-7, wherein mixing the second reagent with the sample stream of the wash treatment solution comprises controlling a flow rate of a stream of the second reagent to cause the sample stream to have the pH in the predefined range.
Aspect 9: The method of any of Aspects 6-8, wherein mixing the second reagent with the sample stream of the wash treatment solution comprises causing a stream of the second reagent to enter a Venturi mixing tube in which the sample stream is flowing.
Aspect 10: The method of any of Aspects 1-9, wherein reducing the silver ions in the sample stream comprises exposing the sample stream to an ultraviolet (UV) light source.
Aspect 11: The method of Aspect 10, wherein the sample stream flows in a coil around the UV light source.
Aspect 12: The method of any of Aspects 1-11, wherein the wash treatment solution comprises an acidulant, a polyol, chlorine-free water, and silver dihydrogen citrate.
Aspect 13: The method of any of Aspects 1-12, wherein the optically measuring comprises: introducing an optical beam into the sample stream; and determining at least one of an optical absorbance, optical turbidity, or optical scattering of the optical beam in the sample stream, wherein the concentration of the colloidal silver is based on the at least one of the optical absorbance, optical turbidity, or optical scattering of the optical beam in the sample stream.
Aspect 14: The method of any of Aspects 1-13, wherein the optically measuring comprises optically measuring the colloidal silver in the sample stream in a flow cell having an internal volume between 0.5 milliliters (mL) and 1.0 mL, inclusive.
Aspect 15: The method of any of Aspects 1-14, wherein the sample stream of the wash treatment solution has a flow rate between 1.5 milliliters per minute (mL/min) and 5.0 mL/min, inclusive.
Aspect 16: The method of any of Aspects 1-15, further comprising adding a quantity of a silver ion solution to a reservoir of the wash treatment solution, based on the measured concentration of the colloidal silver.
Aspect 17: The method of Aspect 16, wherein the silver ion solution comprises silver dihydrogen citrate.
Aspect 18: The method of any of Aspects 1-17, further comprising: measuring a quantity of the wash treatment solution in a reservoir; and adding a quantity of at least one of an acidulant, a polyol, or chlorine-free water to the reservoir, based on the measured quantity of the wash treatment solution.
Aspect 19: The method of any of Aspects 1-18, further comprising: measuring a pH of the wash treatment solution; and adding a quantity of at least one of sodium hydroxide (NaOH), potassium hydroxide (KOH), an acidulant, a polyol, or chlorine-free water to a reservoir of the wash treatment solution, based on the measured pH of the wash treatment solution.
Aspect 20: The method of any of Aspects 1-19, further comprising, based on the measured concentration of the colloidal silver, at least one of: adding a quantity of a silver ion solution to a reservoir of the wash treatment solution; adding a quantity of an acidulant to the reservoir of the wash treatment solution; adding a quantity of a polyol to the reservoir of the wash treatment solution; or adding a quantity of chlorine-free water to the reservoir of the wash treatment solution.
Aspect 21: The method of any of Aspects 1-20, further comprising washing netted melons with the wash treatment solution.
Aspect 22: The method of any of Aspects 1-20, further comprising washing fruit with a rough surface using the wash treatment solution.
Aspect 23: An apparatus for controlling a wash treatment solution for a food product, comprising: at least one memory storing computer-executable instructions and at least one processor coupled to the at least one memory and configured to execute the computer-executable instructions to cause the apparatus to: control reduction of silver ions in a sample stream of the wash treatment solution to form colloidal silver in the sample stream; control an optical measurement of a concentration of the colloidal silver in the sample stream; and receive an indication of the concentration of the colloidal silver in the sample stream.
Aspect 24: The apparatus of Aspect 23, wherein the at least one processor is configured to execute the computer-executable instructions to further cause the apparatus to output a control signal to cause addition of a quantity of a silver ion solution to a reservoir of the wash treatment solution, based on the indication of the concentration of the colloidal silver.
Aspect 25: The apparatus of Aspect 23 or 24, wherein to cause the apparatus to control the reduction of the silver ions, the at least one processor is configured to execute the computer-executable instructions to cause the apparatus to output a control signal configured to cause addition of a first reagent to the sample stream, wherein the first reagent is configured to cause the reduction of the silver ions in the sample stream of the wash treatment solution to form the colloidal silver.
Aspect 26: The apparatus of Aspect 25, wherein the at least one processor is configured to execute the computer-executable instructions to further cause the apparatus to output another control signal configured to cause addition of a second reagent to the sample stream, wherein the second reagent is configured to cause the sample stream to have a pH in a predefined range.
Aspect 27: The apparatus of Aspect 26, wherein the other control signal is configured to control a flow rate of a stream of the second reagent to cause the sample stream to have the pH in the predefined range.
Aspect 28: The apparatus of Aspect 25, wherein the control signal is configured to control a flow rate of a stream of the first reagent to cause the reduction of the silver ions in the sample stream.
Aspect 29: The apparatus of any of Aspects 23-28, wherein the at least one processor is configured to execute the computer-executable instructions to further cause the apparatus to output a control signal to expose the sample stream to light, wherein the light is configured to cause reduction of the silver ions in the sample stream to form the colloidal silver.
Aspect 30: The apparatus of Aspect 29, wherein the light comprises ultraviolet (UV) light and wherein the control signal is configured to control a UV light source configured to provide the UV light.
Aspect 31: The apparatus of any of Aspects 23-30, wherein to cause the apparatus to control the optical measurement, the at least one processor is configured to cause the apparatus to: introduce an optical beam into the sample stream; determine at least one of an optical absorbance, optical turbidity, or optical scattering of the optical beam in the sample stream; and determine the concentration of the colloidal silver based on the at least one of the optical absorbance, optical turbidity, or optical scattering of the optical beam in the sample stream.
Aspect 32: The apparatus of any of Aspects 23-31, further comprising a flow cell having an internal volume between 0.5 milliliters (mL) and 1.0 mL, inclusive, wherein to cause the apparatus to control the optical measurement, the at least one processor is configured to cause the apparatus to control the optical measurement of the colloidal silver in the sample stream in the flow cell.
Aspect 33: The apparatus of any of Aspects 23-32, wherein the at least one processor is configured to execute the computer-executable instructions to further cause the apparatus to: measure a quantity of the wash treatment solution in a reservoir; and add a quantity of at least one of an acidulant, a polyol, or chlorine-free water to the reservoir, based on the measured quantity of the wash treatment solution.
Aspect 34: The apparatus of any of Aspects 23-33, wherein the at least one processor is configured to execute the computer-executable instructions to further cause the apparatus to: measure a pH of the wash treatment solution; and add a quantity of at least one of sodium hydroxide (NaOH), potassium hydroxide (KOH), an acidulant, a polyol, or chlorine-free water to a reservoir of the wash treatment solution, based on the measured pH of the wash treatment solution.
Aspect 35: The apparatus of any of Aspects 23-34, wherein the at least one processor is configured to execute the computer-executable instructions to further cause the apparatus to at least one of: add a quantity of a silver ion solution to a reservoir of the wash treatment solution, based on the indication of the concentration of the colloidal silver; add a quantity of an acidulant to the reservoir of the wash treatment solution, based on the indication of the concentration of the colloidal silver; add a quantity of a polyol to the reservoir of the wash treatment solution, based on the indication of the concentration of the colloidal silver; or add a quantity of chlorine-free water to the reservoir of the wash treatment solution, based on the indication of the concentration of the colloidal silver.
Aspect 36: A processing system comprising at least one memory storing computer-executable instructions and one or more processors configured to execute the computer-executable instructions and cause the processing system to perform a method in accordance with any of Aspects 1-22.
Aspect 37: A system comprising means for performing a method in accordance with any of Aspects 1-22.
Aspect 38: A non-transitory computer-readable medium comprising computer-executable instructions that, when executed by one or more processors of a processing system, cause the processing system to perform a method in accordance with any of Aspects 1-22.
Aspect 39: A computer program product embodied on a computer-readable storage medium comprising code for performing a method in accordance with any of Aspects 1-22.

While the present disclosure has included detail in connection with only a limited number of embodiments, it should be readily understood that the present disclosure is not limited to such described embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

The term “about” is intended to include the degree of error associated with measurement of the particular quantity based upon the equipment available at the time of filing the application. For example, “about” may include a range of ±8%, 5%, or 2% of a given value.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof.

Therefore, it is intended that the present disclosure not be limited to the particular embodiment described as the best mode contemplated for carrying out this present disclosure, but that the present disclosure will include all embodiments falling within the scope of the claims.

1. A method of controlling a wash treatment solution for a food product, comprising:
obtaining a sample stream of the wash treatment solution, wherein the wash treatment solution comprises silver ions;
reducing the silver ions in the sample stream to form colloidal silver in the sample stream; and
optically measuring a concentration of the colloidal silver in the sample stream.

2. The method of claim 1, wherein reducing the silver ions in the sample stream comprises mixing a first reagent with the sample stream of the wash treatment solution and wherein the first reagent causes the reduction of the silver ions in the sample stream to form the colloidal silver in the sample stream.

3. The method of claim 2, wherein the first reagent comprises at least one of:
an aldehyde;
a mercaptan;
ascorbic acid; or
erythorbic acid.

4. The method of claim 2, wherein mixing the first reagent with the sample stream comprises controlling a flow rate of a stream of the first reagent to cause the reduction of the silver ions in the sample stream.

5. The method of claim 2, wherein mixing the first reagent with the sample stream comprises causing a stream of the first reagent to enter a Venturi mixing tube in which the sample stream is flowing.

6. The method of claim 2, further comprising mixing a second reagent with the sample stream of the wash treatment solution before the reducing, wherein the second reagent causes the sample stream to have a pH in a predefined range.

7. The method of claim 6, wherein the second reagent comprises at least one of:
sodium hydroxide (NaOH); or
potassium hydroxide (KOH).

8. The method of claim 6, wherein mixing the second reagent with the sample stream of the wash treatment solution comprises controlling a flow rate of a stream of the second reagent to cause the sample stream to have the pH in the predefined range.

9. The method of claim 6, wherein mixing the second reagent with the sample stream of the wash treatment solution comprises causing a stream of the second reagent to enter a Venturi mixing tube in which the sample stream is flowing.

10. The method of claim 1, wherein reducing the silver ions in the sample stream comprises exposing the sample stream to an ultraviolet (UV) light source.

11. The method of claim 10, wherein the sample stream flows in a coil around the UV light source.

12. The method of claim 1, wherein the wash treatment solution comprises an acidulant, a polyol, chlorine-free water, and silver dihydrogen citrate.

13. The method of claim 1, wherein the optically measuring comprises:
introducing an optical beam into the sample stream; and
determining at least one of an optical absorbance, optical turbidity, or optical scattering of the optical beam in the sample stream, wherein the concentration of the colloidal silver is based on the at least one of the optical absorbance, optical turbidity, or optical scattering of the optical beam in the sample stream.

14. The method of claim 1, further comprising adding a quantity of a silver ion solution to a reservoir of the wash treatment solution, based on the measured concentration of the colloidal silver.

15. The method of claim 14, wherein the silver ion solution comprises silver dihydrogen citrate.

16. The method of claim 1, further comprising:
measuring a quantity of the wash treatment solution in a reservoir; and
adding a quantity of at least one of an acidulant, a polyol, or chlorine-free water to the reservoir, based on the measured quantity of the wash treatment solution.

17. The method of claim 1, further comprising:
measuring a pH of the wash treatment solution; and
adding a quantity of at least one of sodium hydroxide (NaOH), potassium hydroxide (KOH), an acidulant, a polyol, or chlorine-free water to a reservoir of the wash treatment solution, based on the measured pH of the wash treatment solution.

18. The method of claim 1, further comprising, based on the measured concentration of the colloidal silver, at least one of:
adding a quantity of a silver ion solution to a reservoir of the wash treatment solution;
adding a quantity of an acidulant to the reservoir of the wash treatment solution;
adding a quantity of a polyol to the reservoir of the wash treatment solution; or
adding a quantity of chlorine-free water to the reservoir of the wash treatment solution.

19. The method of claim 1, further comprising washing netted melons with the wash treatment solution.

20. The method of claim 1, further comprising washing fruit with a rough surface using the wash treatment solution.

21. An apparatus for controlling a wash treatment solution for a food product, comprising:
at least one memory storing computer-executable instructions; and
at least one processor coupled to the at least one memory and configured to execute the computer-executable instructions to cause the apparatus to:
control reduction of silver ions in a sample stream of the wash treatment solution to form colloidal silver in the sample stream;
control an optical measurement of a concentration of the colloidal silver in the sample stream; and
receive an indication of the concentration of the colloidal silver in the sample stream.

22. The apparatus of claim 21, wherein the at least one processor is configured to execute the computer-executable instructions to further cause the apparatus to output a control signal to cause addition of a quantity of a silver ion solution to a reservoir of the wash treatment solution, based on the indication of the concentration of the colloidal silver.

23. The apparatus of claim 21, wherein:
to cause the apparatus to control the reduction of the silver ions, the at least one processor is configured to execute the computer-executable instructions to cause the apparatus to output a control signal configured to cause addition of a first reagent to the sample stream; and
the first reagent is configured to cause the reduction of the silver ions in the sample stream of the wash treatment solution to form the colloidal silver.

24. The apparatus of claim 23, wherein the at least one processor is configured to execute the computer-executable instructions to further cause the apparatus to output another control signal configured to cause addition of a second reagent to the sample stream and wherein the second reagent is configured to cause the sample stream to have a pH in a predefined range.

25. The apparatus of claim 24, wherein the other control signal is configured to control a flow rate of a stream of the second reagent to cause the sample stream to have the pH in the predefined range.

26. The apparatus of claim 23, wherein the control signal is configured to control a flow rate of a stream of the first reagent to cause the reduction of the silver ions in the sample stream.

27. The apparatus of claim 21, wherein the at least one processor is configured to execute the computer-executable instructions to further cause the apparatus to output a control signal to expose the sample stream to light, the light being configured to cause the reduction of the silver ions in the sample stream to form the colloidal silver.

28. The apparatus of claim 27, wherein the light comprises ultraviolet (UV) light and wherein the control signal is configured to control a UV light source configured to provide the UV light.

29. The apparatus of claim 21, wherein to cause the apparatus to control the optical measurement, the at least one processor is configured to cause the apparatus to:
introduce an optical beam into the sample stream;
determine at least one of an optical absorbance, optical turbidity, or optical scattering of the optical beam in the sample stream; and
determine the concentration of the colloidal silver based on the at least one of the optical absorbance, optical turbidity, or optical scattering of the optical beam in the sample stream.

30. The apparatus of claim 21, further comprising a flow cell having an internal volume between 0.5 milliliters (mL) and 1.0 mL, inclusive, wherein to cause the apparatus to control the optical measurement, the at least one processor is configured to cause the apparatus to control the optical measurement of the colloidal silver in the sample stream in the flow cell.

31. The apparatus of claim 21, wherein the at least one processor is configured to execute the computer-executable instructions to further cause the apparatus to:
measure a quantity of the wash treatment solution in a reservoir; and
add a quantity of at least one of an acidulant, a polyol, or chlorine-free water to the reservoir, based on the measured quantity of the wash treatment solution.

32. The apparatus of claim 21, wherein the at least one processor is configured to execute the computer-executable instructions to further cause the apparatus to:
measure a pH of the wash treatment solution; and
add a quantity of at least one of sodium hydroxide (NaOH), potassium hydroxide (KOH), an acidulant, a polyol, or chlorine-free water to a reservoir of the wash treatment solution, based on the measured pH of the wash treatment solution.

33. The apparatus of claim 21, wherein the at least one processor is configured to execute the computer-executable instructions to further cause the apparatus to at least one of:
add a quantity of a silver ion solution to a reservoir of the wash treatment solution, based on the indication of the concentration of the colloidal silver;
add a quantity of an acidulant to the reservoir of the wash treatment solution, based on the indication of the concentration of the colloidal silver;
add a quantity of a polyol to the reservoir of the wash treatment solution, based on the indication of the concentration of the colloidal silver; or
add a quantity of chlorine-free water to the reservoir of the wash treatment solution, based on the indication of the concentration of the colloidal silver.
